(19) United States
(12) Patent Application Publication
(10) Pub. No.: US 2010/0278169 A1
(43) Pub. Date: Nov. 4, 2010

(54) BI DIRECTIONAL DECODE AND FORWARD RELAY

(75) Inventors: Haifeng Wang, Shanghai (CN); Jing Xi, Shanghai (CN); Ting Zhou, Shanghai (CN); Jiang Wang, Zhujia (CN)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/742,721

(22) PCT Filed: Nov. 11, 2008
(86) PCT No.: PCT/IB2008/054771

§ 371 Date: Jul. 22, 2010

Related U.S. Application Data
(60) Provisional application No. 61/003,100, filed on Nov. 13, 2007.

(51) Int. Cl. H04J 3/00

(52) U.S. Cl. 370/345

(57) ABSTRACT

Methods, apparatus and computer program product provide a bi-directional decode and forward relay having at least 2N antennas configured to perform transmit and receive operations in a wireless communications network; radio apparatus configured to perform relay operations through the at least 2N antennas with at least two other communications devices operative in the wireless communications network, each of the at least two other communications devices having N antennas; and a controller configured to operate the radio apparatus to receive data from the at least two communications devices at a time slot K; to jointly encode the data received from the at least two communications devices using at least one of an XOR or a sum operation; and at a time slot (K+1) to operate the radio apparatus to transmit via one antenna the jointly encoded data to the at least two communications devices.

### TECHNICAL FIELD

The exemplary and non-limiting embodiments of this invention relate generally to wireless communication systems, methods, devices and computer program products and, more specifically, relate to techniques to relay a radio frequency signal between a source and a destination.

### BACKGROUND

Relay technology is utilized to increase system coverage performance and enable high spectrum band usage. A bi-directional relay is intended to improve the spectrum efficiency through the use of bi-directional traffic flow between two nodes.

P. Larsson, N. Johansson and K.-E. Sunell, “Coded bi-directional relaying,” in 5th Scandinavian Workshop on Ad Hoc Networks (ADHOC'05), Stockholm, Sweden, May 2005 describe a bi-directional decode and forward (DF) scheme that uses three time slots to implement bi-directional data transmission.

Petar Popovski and Hiroyuki Yomo. “Bi-directional Amplification of Throughput in a Wireless Multi-Hop Network,” Vehicular Technology Conference, 2006. VTC 2006-Spring. IEEE 63rd. Volume 2, 2006 Page(s):588-593 (describe a bi-directional amplification and forward (AF) relay method that uses two time slots to implement bi-directional data transmission with improved the spectrum efficiency. In this publication relaying techniques are described that increase the achievable throughput in multi-hop wireless networks by taking advantage of bi-directional traffic flow. Such a relaying technique is termed relaying with Bi-directional Amplification of Throughput (BAT-relaying). The BAT-relaying utilizes a concept of anti-packets, defined for bi-directional traffic flows. The relay node combines the packets (anti-packets) that are destined for different nodes and broadcasts the combined packet. A first variant, termed Decode-and-Forward (DF) BAT relaying, combines the packets by using the XOR operation A second variant of BAT-relaying is based on Amplify-and-Forward (AF), which utilizes the inherent packet combining that emerges from simultaneous utilization of a multiple access channel.

One significant disadvantage of these and similar amplification and forward relay methods is that the receiver needs to have knowledge of channel state information (CSI) of each of two links in a two-hop network.

FIG. 1 illustrates the conventional bi-directional decode and forward (DF) relay scheme proposed by Larsson et al. At time slot k and time slot (k+1) a relay node receives data (x) from a first node, such as a user equipment (UE), and data (y) from a second node, such as a base station (BS), respectively. The relay node jointly encodes the data estimates from the BS and the UE through a bit-wise XOR (exclusive OR) operation. The BS and the UE exploit a priori information of the originally transmitted data to decode the jointly encoded data packet.

In this bi-directional DF relay technique three time slots are required, the data estimates from the BS and the UE at the relay node should be correct to avoid error propagation, and the UE and the BS do not require the CSI of the two links.

FIG. 2 illustrates the conventional bi-directional amplification and forward (AF) relay scheme as proposed by Popovski et al. At time slot k the BS and UE simultaneously transmit data destined for each other to the relay node. At time slot (k+1), the relay node amplifies and forwards the received data to the BS and to the UE. The relay node transmission is given by:

y=β(h_{UR}x+h_{BR}y+n), where

β is an amplification factor to make transmission power constant, h_{UR} is the channel fading coefficient from the UE to the relay node, h_{BR} is the channel fading coefficient from the BS to the relay node, and n is the AWGN at the relay node.

In this bi-directional AF relay technique only two time slots are required, but the UE and the BS both require the CSI of the two links (UE-relay, and BS-relay).

As can be appreciated, both of these DF and AF approaches are less than optimum, as the first, DF approach requires three time slots to accomplish, while the second requires the UE and the BS require to know the CSI of the links to the relay node.

Another document of interest is IST-4-027756, WINNER II, D3.5.2 v1.0, “Assessment of relay based deployment concepts and detailed description of multi-hop capable RAN protocols as input for the concept group work”, 30 Jun. 2007, Editors: Klaus Doppler, Simone Redana, Daniel Schultz, Niklas Johansson, Michal Wodczak, Peter Rost, Quiliano Pérez, Halim Yanikomeroglu, Afif Osseiran, Mark Naden, Peter Moberg, Ralf Pabst, Antonio Frediani, Lino Moretti and Martin Fuchs.

### SUMMARY OF THE INVENTION

A first embodiment of the invention is an apparatus comprising: at least 2N antennas configured to perform transmit and receive operations in a wireless communications network; radio apparatus configured to perform relay operations through the at least 2N antennas with at least two other communications devices operative in the wireless communications network, each of the at least two other communications devices having N antennas; and a controller configured to operate the radio apparatus to receive data from the at least two communications devices at a time slot K; to jointly encode the data received from the at least two communications devices using at least one of an XOR or a sum operation; and at a time slot (K+1) to operate the radio apparatus to transmit via one antenna the jointly encoded data to the at least two communications devices.

A second embodiment of the invention is an apparatus comprising: at least 2N antennas configured to perform transmit and received operations in a wireless communications network; radio apparatus configured to perform relay operations through the at least 2N antennas with at least two other communications devices operative in the wireless communications network, each of the at least two communications devices having 2N antennas; and a controller configured to operate the radio apparatus and the at least 2N antennas to receive data from the at least two communications devices at a time slot K wherein the data is transmitted by the at least two communications devices using N antennas; to estimate the data received through the 2N antennas with a 2×2 MIMO receiver; and to transmit the data at time slot (K+1) to the at least two other communications devices.

A third embodiment of the invention is a method comprising: at an apparatus operative in a wireless communications network as a relay wherein the apparatus has 2N antennas, at a time slot K, receiving data from two communications devices operative in the wireless communications network, where the two communications devices have N antennas; estimating at the apparatus data received from the two communications devices; jointly encoding the data received from the two communications devices using at least one of an XOR or a sum operation; and at a time slot (K+1), transmitting via one antenna jointly encoded data to the two communications devices.

A fourth embodiment of the invention is a method comprising: at an apparatus operative in a wireless communications network as a relay wherein the apparatus has 2N antennas, at a time slot K, receiving data with the 2N antennas from two communications devices operative in the wireless communications network, wherein the data is transmitted by the communications devices with N antennas each; estimating the data received through the 2N antennas with a 2×2 MIMO receiver; and at a time slot (K+1), transmitting the data to the two communications devices using the 2N antennas.

A fifth embodiment of the invention is a computer program product comprising a computer-readable memory medium tangibly embodying computer program instructions, the computer program instructions configured to operate an apparatus in a wireless communications network when executed, wherein when the computer program instructions are executed the apparatus is configured to receive at a time slot K data from two communications devices operating in the wireless communications network through 2N antennas, the two communications devices having N antennas; to estimate at the apparatus data received from the two communications devices; to jointly encode the data received from the two communications devices using at least one of an XOR or a sum operations; and at a time slot (K+1), transmitting via one antenna jointly encoded data to the two communications devices.

A sixth embodiment of the invention is a computer program product comprising a computer-readable memory medium tangibly embodying computer program instructions, the computer program instructions configured to operate an apparatus in a wireless communications network when executed, wherein when the computer program instructions are executed the apparatus is configured to receive at a time slot K through 2N antennas from two communications devices operative in the wireless communications network, wherein the data is transmitted by the communications devices with N antennas each; to estimate the data received through the 2N antennas with a 2×2 MIMO receiver; and at a time slot (K+1), to transmit the data to the two communications devices using the 2N antennas.

### BRIEF DESCRIPTION OF THE DRAWINGS

In the attached Drawing Figures:

FIG. 1 shows a conventional bi-directional decode and forward relay approach.

FIG. 2 shows a conventional bi-directional amplification and forward relay approach.

FIGS. 3A and 3B show embodiments of a bi-directional decode and forward relay in accordance with exemplary embodiments of this invention.

FIG. 4 shows a bi-directional decode and forward relay approach, in accordance with another embodiment of this invention, for a case of 2N×2N×2N, where either the UE, BS or the RN has 2N antennas.

FIG. 5 shows a simplified block diagram of various electronic devices that are suitable for use in practicing the exemplary embodiments of this invention.

FIGS. 6 and 7 are each a logic flow diagram that is descriptive of a method, and a result of execution of computer program instructions, in accordance with exemplary embodiments of this invention.

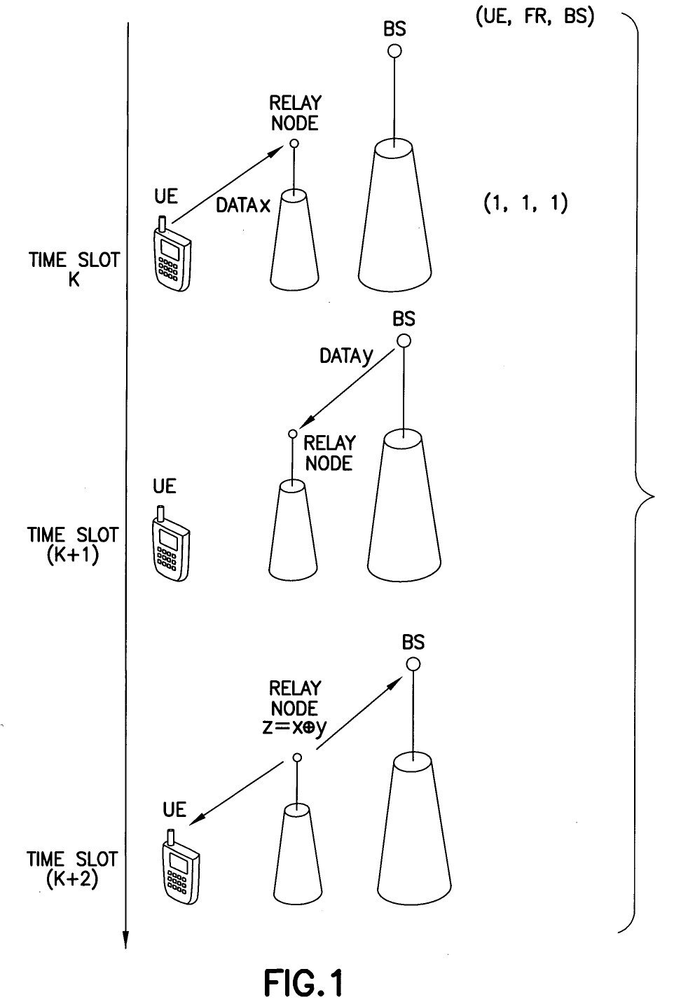

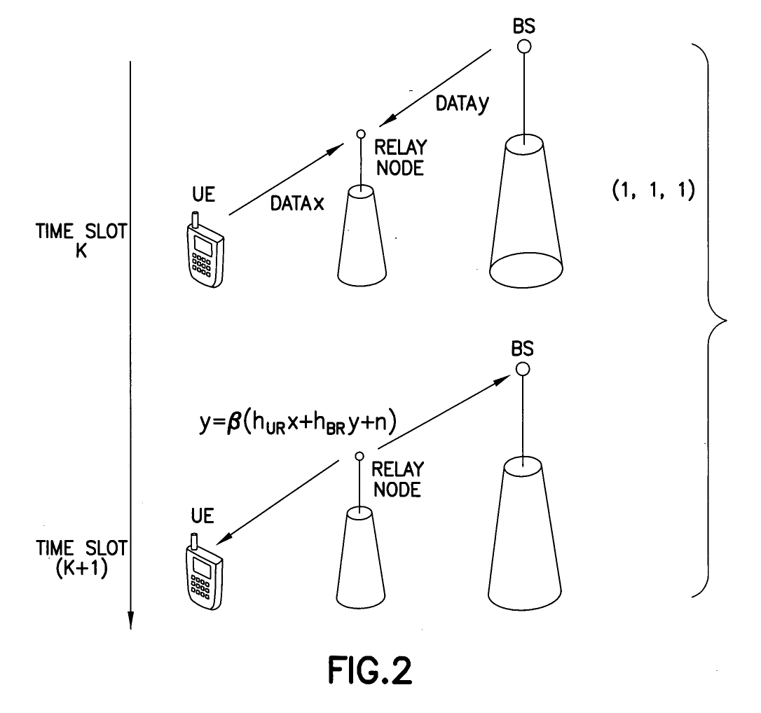

### DETAILED DESCRIPTION

The exemplary embodiments of this invention provide a bi-directional decode and forward (DF) relay scheme that implements bi-directional data transmission within two time slots, and without requiring CSI knowledge of all the involved links.

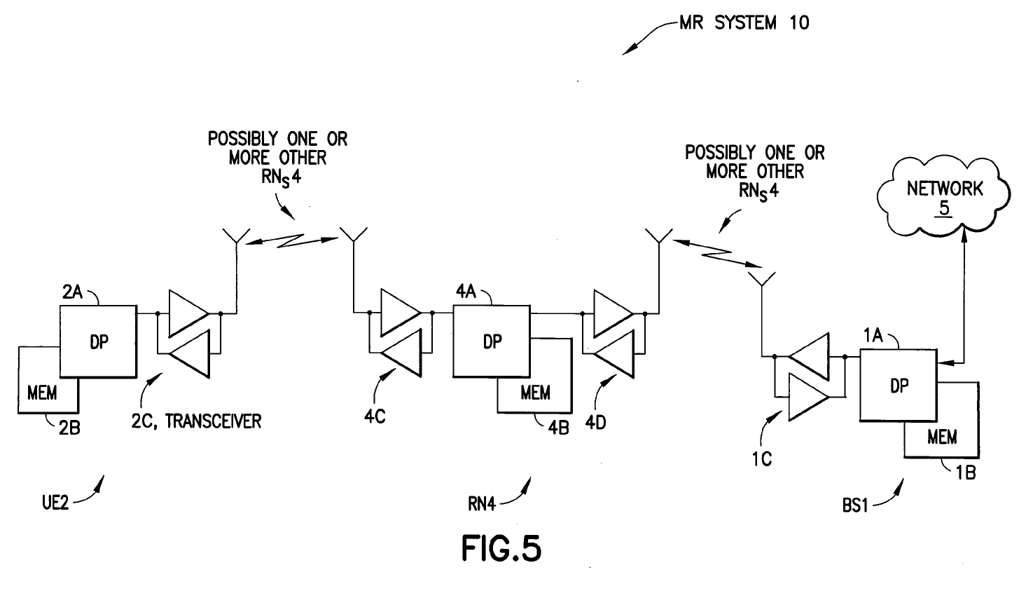

Reference is made first to FIG. 5 for illustrating a simplified block diagram of various electronic devices that are suitable for use in practicing the exemplary embodiments of this invention. In FIG. 5 a relay-based network or system 10 includes at least one mobile station, also referred to herein as a UE 2, at least one relay or relay node (RN) 4, also referred to herein as a FR 4, and at least one BS (or more generally access point (AP)) 1. The UE 2 and BS 1 each include a suitable controller, such as a data processor (DP) 2A, 1A, operatively coupled with a memory (MEM) 2B, 1B, respectively. Each of the UE 2 and BS 1 includes at least one wireless (e.g., radio frequency) transceiver 2C, 1C, respectively. The at least one RN 4 is assumed to be similarly constructed, and may include a DP 4A and associated MEM 4B, and is adapted for communication with the UE 2 and the BS 1 with at least two wireless transceivers 4C, 4D. Note that the RN 4 may be coupled directly to the UE 2, or indirectly coupled via one or more other RNs 4, and may be coupled directly to the BS 1, or indirectly coupled via one or more other RNs 4. At least the memory 4B is assumed to include program instructions, executable by the associated DP 4A for operation in accordance with the exemplary embodiments of this invention, as described in further detail below.

In general, the exemplary embodiments of this invention may be implemented at least in part by computer software executable by the DP 4A, or by hardware, or by a combination of software and hardware.

In general, the various embodiments of the UE 2 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The memories 2B, 1B and 4B may be of any type suitable to the local technical environment and may be implemented using any suitable data storage technology, such as semiconductor-based memory devices, flash memory, magnetic memory devices and systems, optical memory devices and systems, fixed memory and removable memory. The DPs 2A, 1A and 4A may be of any type suitable to the local technical environment, and may include one or more of general purpose computers, special purpose computers, microprocessors, digital signal processors (DSPs) and processors based on a multi-core processor architecture, as non-limiting examples.

Described now are exemplary embodiments of a novel bi-directional decode and forward relay embodied in the RN 4.

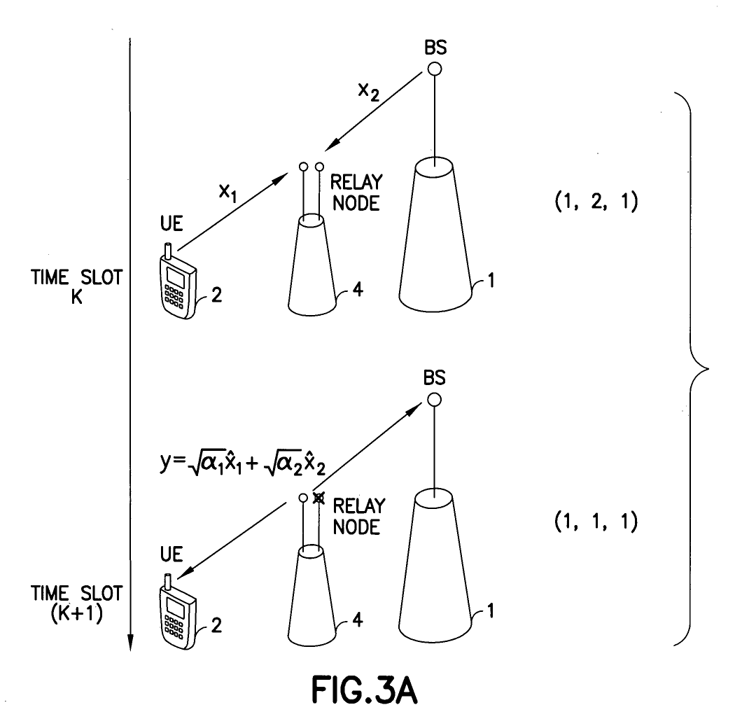

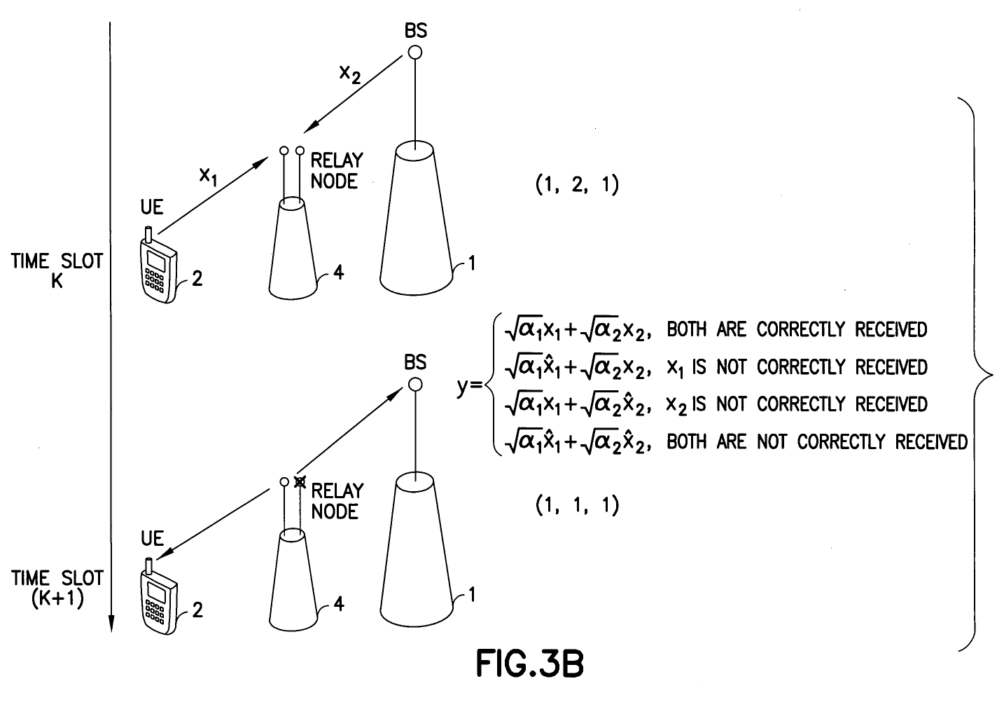

FIGS. 3A and 3B show first exemplary embodiments of the bi-directional decode and forward (DF) relay node (RN 4), for a case of N×2N×N, where the UE 2 and the BS 1 have N antennas, and the RN 4 has 2N antennas.

In this embodiment the antenna with the cross is considered to not be in use. For simplicity of expression, N is assumed to be one. At time slot k, the UE 2 and the BS 1 simultaneously transmit data destined for each other to the RN 4, and the RN 4 estimates the data through two receive antennas. For the purpose the RN 4 may use a conventional 2×2 multiple-input, multiple-output (MIMO) receiver (e.g., one similar to a virtual MIMO or a BLAST receiver). Virtual MIMO techniques are well-known in the art, as evidenced by an exemplary publication “Virtual MIMO-based Cooperative Communication for Energy-constrained Wireless Sensor Networks”, Sudharman K. Jayaweera, IEEE Transactions on Wireless Communications, Vol. 5, No. 5, May 2006.

At time slot (k+1) the RN 4 transmits the jointly encoded data to the UE 2 and the BS 1 using an XOR or a SUM (summation) operation via one antenna. In this case, it can be appreciated that two time slots are used, and that the UE 2 and the BS 1 do not require the CSI of the two links (i.e., the wireless link between the BS 1 and the RN 4, and the wireless link between the UE 2 and the RN 4).

In FIG. 3A the DF RN 4 performs a demodulation and forwarding operation. Its transmission signal is given by the expression:

y=\sqrt{a₁}\hat{x}₁+\sqrt{a₂}\hat{x}₂;

where a₁ and a₂ are power allocation factors, x₁ is the transmitted symbol from the UE 2 to the BS 1, x₂ is the transmitted symbol from the BS 1 to the UE 2, and \hat{x}₁ and \hat{x}₂ are the hard decision of x₁ and x₂ appropriate to the constellation, respectively. An XOR operation may be used instead of the summation.

In FIG. 3B the DF RN 4 performs a channel decode and forwarding operation, or a demodulation and forwarding operation. The RN 4 transmission signal is given by the expression:

$$y = \{ \begin{matrix}\sqrt{{α}_{1}} {x}_{1} + \sqrt{{α}_{2}} {x}_{2} \\ \sqrt{{α}_{1}} {\hat{x}}_{1} + \sqrt{{α}_{2}} {x}_{2} \\ \sqrt{{α}_{1}} {x}_{1} + \sqrt{{α}_{2}} {\hat{x}}_{2} \\ \sqrt{{α}_{1}} {\hat{x}}_{1} + \sqrt{{α}_{2}} {\hat{x}}_{2}\end{matrix}$$

where \hat{x}₁ and \hat{x}₂ are the hard decision of x₁ and x₂ appropriate to the constellation, respectively. When both streams are correctly received, XOR or superposition coding can be performed. Otherwise the RN 4 performs demodulation and forwarding for the wrong stream to avoid error propagation.

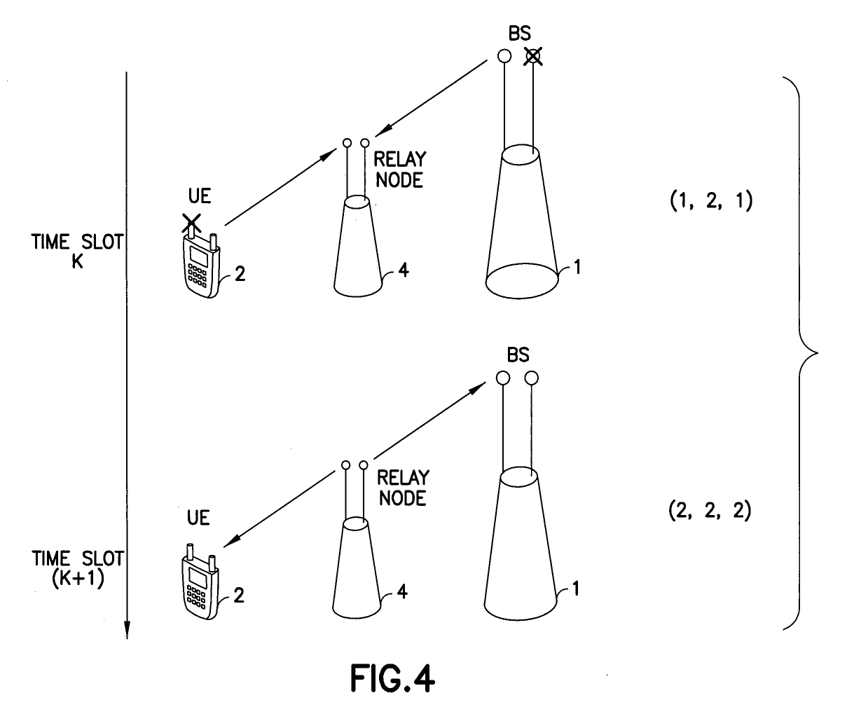

FIG. 4 shows a second exemplary embodiment of the bi-directional decode and forward relay node (RN 4), where each of the UE 2, BS 1 and the RN 4 have 2N antennas. Again, N is assumed to be one for simplicity of expression. At time slot k, the UE 2 and the BS 1 each use one antenna to simultaneously transmit data to the RN 4, and the RN 4 estimates the data through two receive antennas using a conventional 2×2 MIMO receiver (e.g., one similar to a virtual MIMO or a BLAST receiver). At time slot (k+1) the RN 4 transmits the data to UE 2 and the BS 1 via two antennas, respectively. Similarly, the UE 2 and the BS 1 estimate the transmitted data from the RN 4 through two antennas using conventional 2×2 MIMO receivers. In this case, two time slots are used and the UE 2 and the BS 1 do not require the CSI of the two links. This is true at least for the reason that the RN 4 performs the demodulation or channel decoding operation, and neither the UE 2 or the BS 1 need to have knowledge of the channel between the UE 2 and the RN 4, or between the BS 1 and the RN 4.

It may be assumed that some degree of synchronization is present in the system 10. However, it one assumes that a baseline air-interface is an OFDM-based system, the coarse synchronization that is provided in a cyclic prefix window for OFDM symbols is adequate for synchronization purposes.

In general, it is noted that there are at least two approaches to providing relay node operation. In a first approach the RN 4 performs demodulation and the forwarding operation, rather than performing channel decoding and forwarding. In this case, the UE 2 the BS 1 need to know the reliability of the demodulation at the RN 4 so that they may then perform self-interference operations without error propagation. In another approach, a hybrid approach, both streams are correctable through CRC, XOR or superposition coding, otherwise the RN 4 performs demodulation and forwarding for the wrong stream to avoid error propagation.

Based on the foregoing it should be apparent that the exemplary embodiments of this invention provide a method, apparatus and computer program product(s) to provide enhanced decode and forward relay node operation that can be achieved using two time slots, and that does not require that the UE 2 and the BS 1 have knowledge of the CSI of the wireless links between the UE and relay node, and between the BS and the relay node.

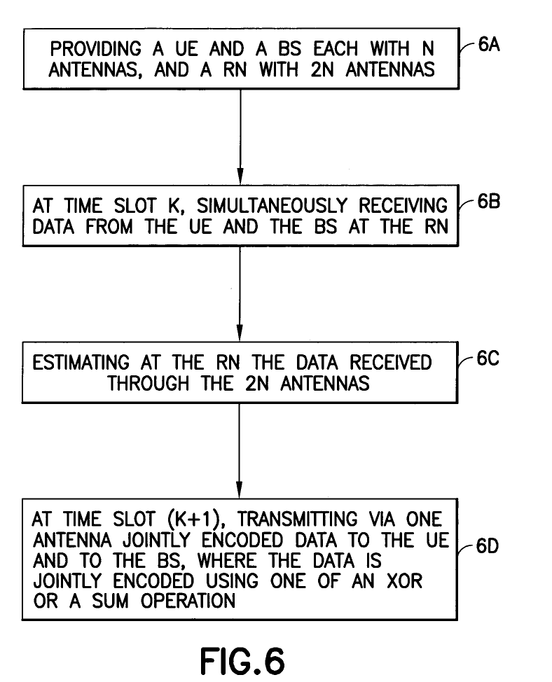

(A) In a first embodiment, and referring to FIG. 6, a method comprises at Block 6A providing a UE and a BS each with N antennas, and a RN with 2N antennas. At Block 6B, and at time slot k, simultaneously receiving data transmitted from the UE and the BS at the RN, at Block 6C estimating at the RN the data received through the 2N antennas; and in Block 6D, at time slot (k+1), transmitting via one antenna jointly encoded data to the UE and to the BS, where the data is jointly encoded using one of an XOR or a SUM operation.

In the method of the preceding paragraph, where the jointly encoded data that is transmitted is given by:

y=\sqrt{a₁}\hat{x}₁+\sqrt{a₂}\hat{x}₂;

where a₁ and a₂ are power allocation factors, x₁ is the transmitted symbol from the UE to the BS, x₂ is the transmitted symbol from the BS to the UE, and \hat{x}₁ and \hat{x}₂ are the hard decision of x₁ and x₂ appropriate to the constellation, respectively. An XOR operation may be used instead of the summation.

The method paragraph (A), where the RN performs a channel decode and forwarding operation, or a demodulation and forwarding operation, and where the jointly encoded data that is transmitted is given by:

$$y = \{ \begin{matrix}\sqrt{{α}_{1}} {x}_{1} + \sqrt{{α}_{2}} {x}_{2} \\ \sqrt{{α}_{1}} {\hat{x}}_{1} + \sqrt{{α}_{2}} {x}_{2} \\ \sqrt{{α}_{1}} {x}_{1} + \sqrt{{α}_{2}} {\hat{x}}_{2} \\ \sqrt{{α}_{1}} {\hat{x}}_{1} + \sqrt{{α}_{2}} {\hat{x}}_{2}\end{matrix}$$

where \hat{x}₁ and \hat{x}₂ are the hard decision of x₁ and x₂ appropriate to the constellation, respectively, and where when both streams are correctly received, XOR or superposition coding can be performed.

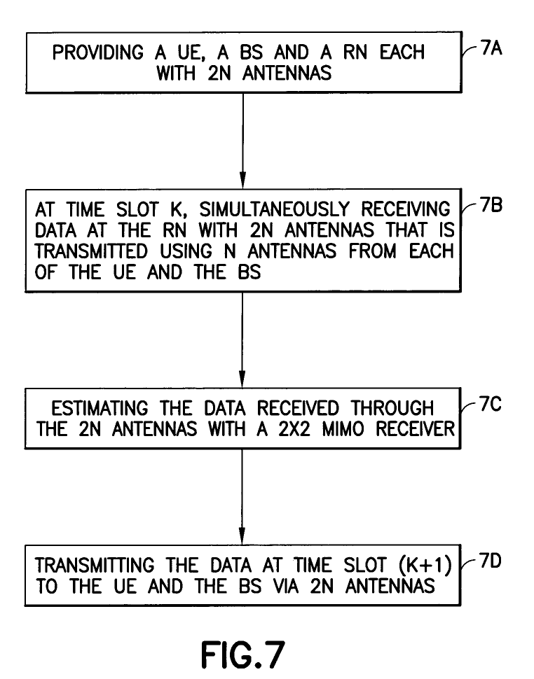

In a another embodiment, and referring to FIG. 7, a method comprises at Block 7A providing a UE, a BS and a RN each with 2N antennas. At Block 7B, and at time slot k, simultaneously receiving data at the RN, with 2N antennas, that is transmitted using N antennas from each of the UE and the BS, at Block 7C estimating the data received through 2N antennas with a 2N×2N MIMO receiver; at Block 7D transmitting the data at time slot (k+1) to the UE and the BS via 2N antennas.

In the method of the preceding paragraph, further comprising receiving the data transmitted from the RN using 2N antennas, and estimating at the received data using a 2N×2N MIMO receiver.

The various blocks shown in FIGS. 6 and 7 may be viewed as method steps, and/or as operations that result from operation of computer program code, and/or as a plurality of coupled logic circuit elements constructed to carry out the associated function(s).

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the inventions may be practiced in various components such as integrated circuit chips and modules. The design of integrated circuits is by and large a highly automated process. Complex and powerful software tools are available for converting a logic level design into a semiconductor circuit design ready to be fabricated on a semiconductor substrate. Such software tools can automatically route conductors and locate components on a semiconductor substrate using well established rules of design, as well as libraries of pre-stored design modules. Once the design for a semiconductor circuit has been completed, the resultant design, in a standardized electronic format (e.g., Opus, GDSII, or the like) may be transmitted to a semiconductor fabrication facility for fabrication as one or more integrated circuit devices.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

For example, while the exemplary embodiments have been described above in the context of the E-UTRAN (UTRAN-LTE) system, it should be appreciated that the exemplary embodiments of this invention are not limited for use with only this one particular type of wireless communication system, and that they may be used to advantage in other wireless communication systems.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

1. An apparatus comprising:
a controller configured to operate a radio apparatus to receive data from at least two communications devices in a wireless network at a time slot K; to jointly encode the data received from the at least two communications devices using at least one of an XOR or a sum operation; and at a time slot (K+1) to operate the radio apparatus to transmit the jointly encoded data to the at least two communications devices.

2. An apparatus as in claim 1 further comprising at least 2N antennas configured to perform transmit and receive operations in the wireless communications network.

3. An apparatus as in claim 2 further comprising the radio apparatus configured to perform relay operations through the at least 2N antennas with at least two other communications devices operative in the wireless communications network, each of the at least two other communications devices having N antennas.

4. An apparatus according to claim 1 wherein the apparatus comprises a relay node.

5. An apparatus according to claim 4 wherein the controller is further configured to perform channel decode and forwarding relay operations.

6. An apparatus according to claim 4 wherein the controller is further configured to perform demodulation and forwarding relay operations.

7-34. (canceled)

35. An apparatus according to claim 1 wherein the jointly encoded data that is transmitted is given by:
y=\sqrt{a₁}\hat{x}₁+\sqrt{a₂}\hat{x}₂;
where a₁ and a₂ are power allocation factors, x₁ is the transmitted symbol from a user equipment (UE) to a base station (BS), x₂ is the transmitted symbol from the BS to the UE, and \hat{x}₁ and \hat{x}₂ are the hard decision of x₁ and x₂.

36. An apparatus according to claim 1 wherein the jointly encoded data that is transmitted is given by:
$$y = \{ \begin{matrix}\sqrt{{α}_{1}} {x}_{1} + \sqrt{{α}_{2}} {x}_{2} \\ \sqrt{{α}_{1}} {\hat{x}}_{1} + \sqrt{{α}_{2}} {x}_{2} \\ \sqrt{{α}_{1}} {x}_{1} + \sqrt{{α}_{2}} {\hat{x}}_{2} \\ \sqrt{{α}_{1}} {\hat{x}}_{1} + \sqrt{{α}_{2}} {\hat{x}}_{2}\end{matrix}$$
where a₁ and a₂ are power allocation factors, x₁ is the transmitted symbol from a UE to a BS, x₂ is the transmitted symbol from the BS to the UE, and \hat{x}₁ and \hat{x}₂ are the hard decision of x₁ and x₂ appropriate to a used constellation.

37. An apparatus according to claim 1 wherein at least one of the communications devices comprises a user equipment.

38. An apparatus according to claim 1 wherein at least one of the communications devices comprises a base station.

39. An apparatus comprising:
a controller configured to operate a radio apparatus and the at least 2N antennas to receive data from the at least two communications devices at a time slot K wherein the data is transmitted by the at least two communications devices using N antennas; to estimate the data received through the 2N antennas with a 2×2 multiple-input-multiple-output (MIMO) receiver; and to transmit the data at time slot (K+1) to the at least two other communications devices using the 2N antennas.

40. An apparatus as in claim 11 further comprising the least 2N antennas configured to perform transmit and receive operations in a wireless communications network.

41. An apparatus as in claim 40 further comprising the radio apparatus configured to perform relay operations through the at least 2N antennas with at least two other communications devices operative in the wireless communications network, each of the at least two communications devices having 2N antennas.

42. An apparatus according to claim 39 wherein the apparatus comprises a relay node.

43. An apparatus according to claim 39 wherein the controller is further configured to perform channel decode and forwarding relay operations.

44. An apparatus according to claim 39 wherein the controller is further configured to perform demodulation and forwarding relay operations.

45. A method comprising:
at an apparatus operative in a wireless communications network as a relay wherein the apparatus has 2N antennas,
at a time slot K, receiving data from two communications devices operative in the wireless communications network, where the two communications devices have N antennas; estimating at the apparatus data received from the two communications devices;
jointly encoding the data received from the two communications devices using at least one of an XOR or a sum operation; and
at a time slot (K+1), transmitting via one antenna jointly encoded data to the two communications devices.

46. A method according to claim 45 wherein the apparatus comprises a relay node.

47. An method according to claim 46 wherein the apparatus is further configured to perform channel decode and forwarding relay operations.

48. A method according to claim 46 wherein the apparatus is further configured to perform demodulation and forwarding relay operations.
